(19) United States
(12) Patent Application Publication
(10) Pub. No.: US 2024/0132041 A1
(43) Pub. Date: Apr. 25, 2024

(54) Brake-fluid conduit for conducting a brake fluid

(71) Applicant: HL MANDO CORPORATION, Pyeongtaek (KR)

(72) Inventor: Hatem SHAHIN, Pfaffenhofen (DE)

(21) Appl. No.: 18/363,384

(22) Filed: Jul. 31, 2023

(30) Foreign Application Priority Data
Oct. 24, 2022 (DE) 102022211306.3

(51) Int. Cl. B60T 17/04

(52) U.S. Cl. CPC B60T 17/04

(57) ABSTRACT

This disclosure describes a brake-fluid conduit for conducting a brake fluid between a fluid pressure supply device and a wheel cylinder of a hydraulic disk brake system. The brake-fluid conduit comprises a tapered portion having a cross-section that is largest at an end of the tapered portion facing the wheel cylinder and that narrows towards an end of the tapered portion facing away from the wheel cylinder.

### CROSS-REFERENCE TO RELATED APPLICATION

This application is based on and claims priority under 35 U.S.C. § 119 to German Patent Application No. 102022211306.3, filed on Oct. 25, 2022 in the German Patent and Trade Mark Office, the disclosures of which are incorporated herein by reference.

### TECHNICAL FIELD

The present disclosure relates to a brake fluid conduit for conducting a brake fluid, a brake-fluid line comprising the brake-fluid conduit, a caliper arrangement for a hydraulic disk-brake system comprising the brake-fluid conduit, and a hydraulic disk-brake system comprising the caliper arrangement.

### BACKGROUND

Car makers force brake suppliers to solve the most important issues of disk-brake systems: squeal noises, drag torque, higher mass of components, pedal travel feeling, brake and disc dust. Particularly, a reduction of drag torque proofs to be a challenging problem.

Drag torque is caused by residual drag as well as suction of pads. Residual drag describes a partial and temporary contacting of brake disk and brake pads during driving. Suction, on the other side, describes a permanent contacting of brake disk and brake pads, wherein the brake pads are suctioned off to a surface of the brake disk.

There are many solutions to reduce residual drag, but few solutions to solve pad suction issues. The reason for those difficulties to prevent suction is that suction occurs during driving under a complex combination of different aerodynamic effects based on temperature, pressure, and angular velocity of the brake disk. In addition, design features of the brake disk also affect whether suction is occurring or not.

### SUMMARY

An objective of the present disclosure is to describe how to improve hydraulic floating-caliper disk brakes.

This objective is realized through the brake-fluid conduit according to claim 1.

The brake-fluid conduit is configured to conduct a brake fluid between a fluid pressure supply device and a wheel cylinder of a hydraulic disk brake system. The brake-fluid conduit according to this disclosure comprises a tapered portion having a cross-section that is largest at an end of the tapered portion facing the wheel cylinder and that narrows towards an end of the tapered portion facing away from the wheel cylinder.

Through the tapered portion of the brake-fluid conduit, turbulences will be created when the brake fluid retracts after the brake pedal is released and the fluid pressure supply device reduces a supplied fluid pressure. These turbulences produce a temporary negative pressure on the end of the tapered portion facing the wheel cylinder and a temporary positive pressure on the end of the tapered portion facing away from the wheel cylinder. For floating-caliper disk brakes, a residual force generated by the pressure difference will retract the caliper from the disk brake, also moving a finger of the caliper housing in axial direction further away from the brake disk. As the finger of the caliper housing is further removed from brake disk, also a brake pad, referred to as outer brake pad, actuated by the finger of the caliper, has more space to axially retract from the disk brake. As a result suction as well as residual drag are reduced.

A further advantage of the described approach is that modifications are limited to the brake-fluid conduit and no additional components are required. Furthermore, the described approach does not introduce additional mass to the brake-fluid conduit.

In addition, As a result of the reduced drag torque, brake pads and brake disk of a disk-brake system comprising the brake-fluid conduit will experience lower wear, which also leads to an overall lower fuel consumption. Also squeal noises are reduced.

In the following, preferred embodiments of the brake-fluid conduit will be described.

The phrases facing the wheel cylinder and facing away from the wheel cylinder used within the present disclosure are to be interpreted in terms of a fluid path connecting the wheel cylinder with the brake-fluid conduit. Therefore, the phrase facing the wheel cylinder describes that end of the brake-fluid conduit or the tapered portion which is closest in terms of the fluid path to the wheel cylinder. The phrase facing away from the wheel cylinder describes that end which is further away from the wheel cylinder in terms of the fluid path.

In the following, preferred embodiments of the brake-fluid conduit with different shapes will be described.

In one of those preferred embodiments, the tapered portion of the brake-fluid conduit narrows continuously. In another preferred embodiment, the tapered portion is cone-like shaped. In yet another embodiment, the brake-fluid channel is, additionally or alternatively, approximately cylindrically shaped in portions surrounding the tapered portion. All these different shapes are particularly advantageous to create the turbulences described above.

In other embodiments, the brake-fluid conduit comprises, additionally or alternatively, a plurality of tapered portions.

In the following, embodiments of the brake-fluid conduit according to this disclosure are described that possess a range of different dimensions of the tapered portion.

In one of those embodiments, a diameter of the cross section of the tapered portion at the end of the tapered portion facing the wheel cylinder lies, additionally or alternatively, in a range between 4 mm and 8 mm.

In another embodiment, a diameter of the cross section of the tapered portion at the end of the tapered portion facing away from the wheel cylinder lies, additionally or alternatively, in a range between 3 mm and 5 mm.

In yet another embodiment, a length of the tapered portion along an axial direction of the brake-fluid channel lies, additionally or alternatively, in a range from 4 to 8 mm.

In another embodiment of the brake-fluid conduit, a ratio between a diameter of the cross section of the tapered portion at the end of the tapered portion facing the wheel cylinder and a diameter of the cross section of the tapered portion at the end of the tapered portion facing away from the wheel cylinder lies, additionally or alternatively, in a range between 1.1 and 2.0.

Also, these dimensions are particularly advantageous to create the turbulences described above.

Lastly, in another embodiment, a ratio between a length of the tapered portion along an axial direction of the brake-fluid conduit and a diameter of the cross section of the tapered portion at the end of the tapered portion facing away from the wheel cylinder lies, additionally or alternatively, in a range between 1.5 to 2.5.

The brake-fluid conduit according to this disclosure can be a part of different components related to hydraulic disk-brake system. The embodiments described in the following all form components of a hydraulic disk-brake system comprising the brake-fluid conduit according to this invention.

In one embodiment, the brake-fluid conduit is comprised by a brake-fluid line. Including the tapered portion into the brake-fluid line is advantageous, because it allows a retrofitting of hydraulic disk-brake system with the brake-fluid conduit.

In another embodiment, the brake-fluid conduit is comprised within a caliper arrangement for a hydraulic disk-brake system comprising a caliper. In one variant of this embodiment, the brake-fluid conduit is comprised within a caliper housing of the caliper. In another variant, the caliper comprises a caliper housing with a wheel cylinder and the tapered portion is arranged in the caliper housing at an interface between the wheel cylinder and the brake-fluid conduit. Integrating the brake-fluid conduit into the caliper housing is advantageous as this can be done during the housing casting, which does not require any additional manufacturing steps.

In another variant of the caliper arrangement, the caliper arrangement comprises, additionally or alternatively, a connection piece for providing a fluid connection between the caliper and a brake-fluid line, wherein at least the tapered portion of the brake fluid conduit is comprised in the connection piece. The inclusion of the brake-fluid conduit into the connection piece also allows a retrofitting of a hydraulic disk-brake system with the brake-fluid conduit.

In yet another embodiment, any of the previously described embodiments of the caliper arrangement are comprised within a hydraulic disk-brake system. The hydraulic disk-brake system shares all advantageous of the brake-fluid conduit itself.

### BRIEF DESCRIPTION OF DRAWINGS

In the following, different embodiments of the dust sheet and the disk-brake arrangement according to this disclosure will be described starting with a short summary of the figures.

FIG. 1 shows a hydraulic disk-brake system as is known in the prior art;

FIG. 2 shows a caliper with a caliper housing comprising the brake-fluid conduit according to the idea of the present disclosure;

FIG. 3 shows another caliper with a caliper housing comprising the brake-fluid conduit according to the idea of the present disclosure;

FIG. 4 shows a caliper arrangement, wherein a brake-fluid conduit according to the idea of the present disclosure is comprised within a brake line; and

FIG. 5 shows a caliper arrangement, wherein a brake-fluid conduit according to the idea of the present disclosure is comprised within a connection piece for providing a fluid connection between the caliper and a brake-fluid line.

### DETAILED DESCRIPTION

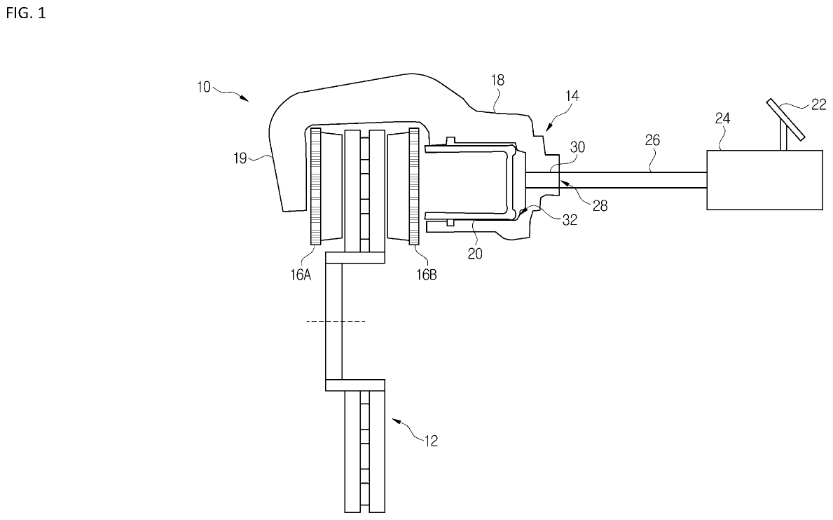

In the following, a detailed description of the figures will be provided. At first, a hydraulic disk-brake system as is known from the prior art will be described with reference to FIG. 1.

FIG. 1 shows a hydraulic disk-brake system 10 as is known in the prior art. The hydraulic disk-brake system 10 comprises a brake disk 12 and a caliper 14 that has a caliper housing 18. The caliper 14 is a floating caliper with a caliper finger 19.

The hydraulic disk-brake system 10 further comprises two brake pads 16A and 16B. The brake pads 16B is actuated by a wheel piston 20 that is located within a wheel cylinder 32 formed by the caliper housing 18. Once a brake pedal 22 is pressed, a fluid pressure supply device 24 supplies pressurized brake fluid through a brake-fluid line 26 to a brake-fluid inlet 28 of the caliper 14, where the pressurized brake fluid reaches the wheel cylinder 32 through a conduit 30 within the caliper housing 18. Through the pressurized brake fluid, the wheel piston 20 is actuated and pushes the brake pad 16B towards the brake disk 12. Since the caliper 14 is a floating caliper, the movement of the wheel piston 20 also moves the caliper finger 19 towards the brake pad 16A pushing the brake pad 16A against the brake disk 12.

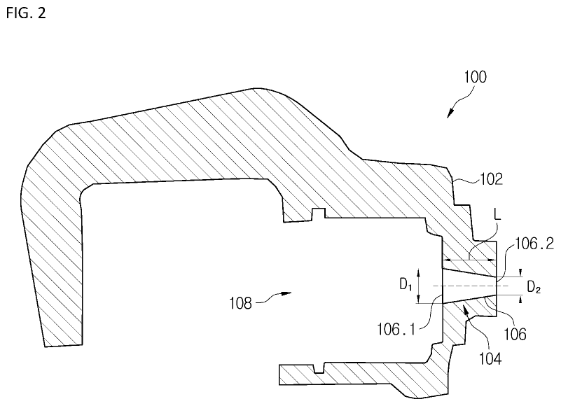

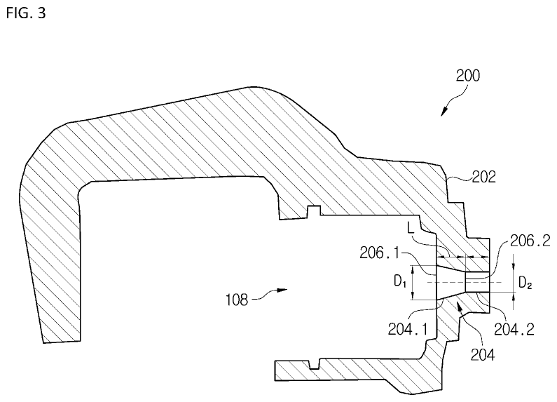

In the following, different embodiments of the brake-fluid conduit according to the idea of the present disclosure will be described. Firstly, the description focusses on different caliper arrangement comprising the brake-fluid conduit according to the idea of the disclosure within a caliper housing as shown in FIG. 2 and FIG. 3.

FIG. 2 shows a caliper 100 with a caliper housing 102 comprising a brake-fluid conduit 104 according to the idea of the present disclosure. The caliper 100 can, for example, be used in the hydraulic disk-brake system shown in FIG. 1 replacing the caliper 14.

The brake-fluid conduit 104 is configured to conduct a brake fluid between a fluid pressure supply device and a wheel cylinder 108 of a hydraulic disk-brake system. The brake-fluid conduit 104 comprises a tapered portion 106 having a cross-section that is largest at an inner end 106.1 of the tapered portion 106 facing the wheel cylinder 108 and that narrows towards an outer end 106.2 of the tapered portion 106 facing away from the wheel cylinder 108.

In the caliper 100, the tapered portion 106 of the brake-fluid conduit 104 narrows continuously. Furthermore, the tapered portion 106 is cone-like shaped.

A diameter D1 of the cross section of the tapered portion 106 at the inner end 106.1 of the tapered portion 106 facing the wheel cylinder 108 lies in a range between 4 mm and 8 mm, specifically 6 mm in this example. Furthermore, a diameter D2 of the cross section of the tapered portion 106 at the outer end 106.2 of the tapered portion 106 facing away from the wheel cylinder 108 lies in a range between 3 mm and 5 mm, specifically 4 mm in this example. A length L of the tapered portion along an axial direction of the brake-fluid conduit lies in a range from 4 to 8 mm, specifically 10 mm in this example.

In the caliper 100 shown in FIG. 2, the tapered portion 106 ranges over an entire length of the brake-fluid conduit 104 comprised within the caliper housing 102. However, in other embodiments, this can be different. An example for such an embodiment will be described in the following with reference to FIG. 3.

FIG. 3 shows another caliper 200 with a caliper housing 202 comprising the brake-fluid conduit 204 according to the idea of the present disclosure.

In the following, the description will focus on those elements shown in the figures that have not been described previously. Those elements that have been previously shown and described will be labelled with the same reference sign. For a detailed description, the reader is referred back to the description of those figures where the element is first shown and labelled.

The caliper housing 202 is largely identical to the caliper housing 102 shown in FIG. 2. It differs only with regard to brake-fluid conduit 204. The brake-fluid conduit 204 comprises two parts. A first part 204.1 corresponds to the tapered portion 106 of caliper 100. A second part 204.2 corresponds to a brake-fluid channel that is cylindrically shaped and does not narrow. Furthermore, the tapered portion 204.1 is arranged at an interface between the wheel cylinder 108 and the brake-fluid conduit 204, which is identical to the inner end 206.1 of the tapered portion 204.1.

A diameter D1 of the cross section of the tapered portion 204.1 at an inner end 206.1 of the tapered portion 204.1 facing the wheel cylinder 108 and a diameter D2 of the cross section of the tapered portion 204.1 at an outer end 206.2 of the tapered portion 204.1 facing away from the wheel cylinder 108 lies in a range between 1.1 and 2.0.

Furthermore, a ratio between a length L of the tapered portion 204.1 along an axial direction of the brake-fluid conduit 204 and the diameter D1 of the cross section of the tapered portion 204.1 at the outer end 206.1 of the tapered portion 204.1 facing the wheel cylinder 108 lies in a range between 1.5 to 2.5.

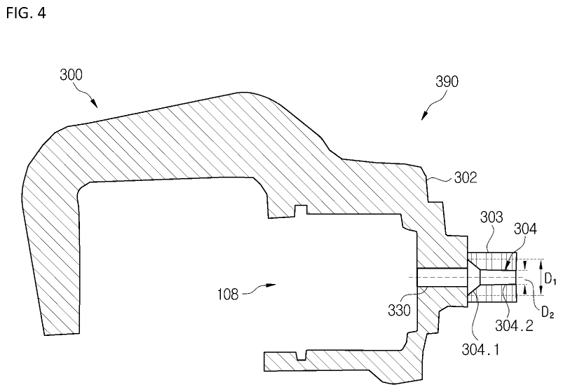

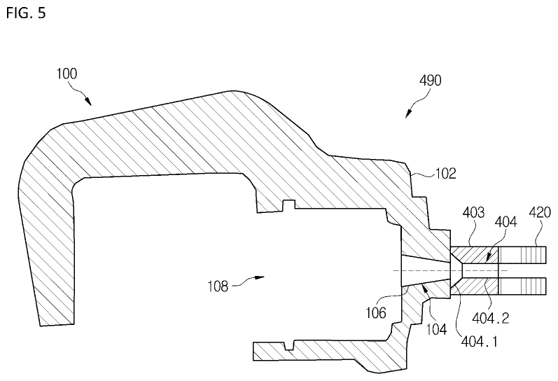

The brake-fluid conduit according to the idea of the present disclosure does not have to be comprised within the housing of a caliper. It can also be comprised within a brake line or a connection piece connecting a caliper and a brake line. Embodiments showing these features will be described in the following with reference to FIG. 4 and FIG. 5.

FIG. 4 shows a caliper arrangement 300, wherein a brake-fluid conduit 304 according to the idea of the present disclosure is comprised within a brake-fluid line 303.

The caliper arrangement 300 comprises a caliper 301 with a caliper housing 302, which is identical to that of the prior art shown in FIG. 1. Attached to a brake-fluid channel 330 that leads to the wheel cylinder 108 formed by the caliper housing 302 is a brake line 303, of which only a part is shown. The brake-fluid line 303 comprises a brake-fluid conduit 304 according to the idea of the present disclosure. The brake-fluid conduit 303 comprises two parts. A first part 304.1 corresponds to the tapered portion that has a cross-section that is largest at an end of the tapered portion 304.1 facing the wheel cylinder 108 and that narrows towards an end of the tapered portion 304.1 facing away from the wheel cylinder 108. A second part 304.2 is cylindrically shaped.

Instead of in the brake-fluid line, the brake-fluid conduit can also be comprised within a connection piece connecting caliper and brake-fluid line. Such an embodiment will be described in the following with reference to FIG. 5.

FIG. 5 shows a caliper arrangement 490, wherein a brake-fluid conduit 404 according to the idea of the present invention is comprised within a connection piece 403 for providing a fluid connection between the caliper 100 and a brake-fluid line 420.

In the caliper arrangement 490, the brake-fluid conduit 403 according to the idea of the present disclosure is comprised within the connection piece 403 that provides a fluid connection between the brake-fluid line 420 and the caliper 100. Similar as the brake-fluid line 304 of FIG. 4, the brake-fluid conduit 404 comprised within the connection piece 403 has two parts. A first part 404.1 corresponds to the tapered portion that has a cross-section that is largest at an end of the tapered portion 404.1 facing the wheel cylinder 108 and that narrows towards an end of the tapered portion 404.1 facing away from the wheel cylinder 108. A second part 404.2 is cylindrically shaped.

Furthermore, the caliper arrangement 490 shows, how a plurality of tapered portions can be combined with each other. In the example shown in FIG. 5, one tapered portion is comprised within the connection piece, while another tapered portion is comprised within the caliper 100.

In summary, this disclosure describes a brake-fluid conduit (106) for conducting a brake fluid between a fluid pressure supply device (24) and a wheel cylinder (108) of a hydraulic disk brake system. The brake-fluid conduit (104) comprises a tapered portion (106) having a cross-section that is largest at an end (106.1) of the tapered portion (106) facing the wheel cylinder (108) and that narrows towards an end (106.2) of the tapered portion (106) facing away from the wheel cylinder (108).

What is claimed is:

1. A brake-fluid conduit for conducting a brake fluid between a fluid pressure supply device and a wheel cylinder of a hydraulic disk brake system, wherein
the brake-fluid conduit comprises a tapered portion having a cross-section that is largest at an inner end of the tapered portion facing the wheel cylinder and that narrows towards an outer end of the tapered portion facing away from the wheel cylinder.

2. The brake-fluid conduit according to claim 1, wherein the tapered portion narrows continuously.

3. The brake-fluid conduit according to claim 1, wherein the tapered portion is cone-like shaped.

4. The brake-fluid conduit according to claim 1, wherein a brake-fluid channel adjacent to the tapered portion is approximately cylindrically shaped.

5. The brake-fluid conduit according to claim 1, wherein a diameter of the cross section of the tapered portion at the inner end of the tapered portion facing the wheel cylinder lies in a range between 4 mm and 8 mm.

6. The brake-fluid conduit according to claim 5, wherein a diameter of the cross section of the tapered portion at the outer end of the tapered portion facing away from the wheel cylinder lies in a range between 3 mm and 5 mm.

7. The brake-fluid conduit according to claim 6, wherein a length of the tapered portion along an axial direction of the brake-fluid channel lies in a range from 4 to 8 mm.

8. The brake-fluid conduit according to claim 1, wherein a ratio between a diameter of the cross section of the tapered portion at the inner end of the tapered portion facing the wheel cylinder and a diameter of the cross section of the tapered portion at the outer end of the tapered portion facing away from the wheel cylinder lies in a range between 1.1 and 2.0.

9. The brake-fluid conduit according to claim 8, wherein a ratio between a length of the tapered portion along an axial direction of the brake-fluid conduit and a diameter of the cross section of the tapered portion at the inner end of the tapered portion facing the wheel cylinder lies in a range between 1.5 to 2.5.

10. A caliper arrangement for a hydraulic disk-brake system, comprising a caliper and the brake-fluid conduit according to claim 1.

11. The caliper arrangement according to claim 10, wherein the brake-fluid conduit is integrated in a housing (102) of the caliper.

12. The caliper arrangement according to claim 10, wherein the caliper arrangement comprises a connection piece for providing a fluid connection between the caliper and a brake-fluid line, wherein at least the tapered portion of the brake-fluid conduit is comprised in the connection piece.
